(19) United States
(12) Patent Application Publication
(10) Pub. No.: US 2012/0016992 A1
(43) Pub. Date: Jan. 19, 2012

(54) ARCHITECTURE FOR IMPROVED CLOUD COMPUTING

(75) Inventors: Bret Weber, Wichita, KS (US); Mark Nossokoff, Fort Collins, CO (US); Brett Pemble, Silverton, OR (US)

(73) Assignee: LSI CORPORATION, Milpitas, CA (US)

(21) Appl. No.: 12/837,634

(22) Filed: Jul. 16, 2010

(51) Int. Cl. G06F 15/173

(52) U.S. Cl. 709/226; 711/114

(57) ABSTRACT

The present invention is directed to an architecture for promoting improved cloud computing. The architecture includes a plurality of diskless server nodes. The architecture further includes a plurality of Serial Attached Small Computer System Interface (SAS) switches, the plurality of SAS switches being connected to the plurality of diskless server nodes. The architecture further includes a storage system, the storage system configured for being communicatively coupled to the plurality of servers via the plurality of SAS switches. Further, the storage system is configured for implementing Controlled Replication Under Scalable Hashing (CRUSH) redundancy. Still further, the architecture is configured for dynamically mapping data stores of the storage system to the diskless server nodes.

### FIELD OF THE INVENTION

The present invention relates to the field of storage resource and data management and particularly to an architecture for promoting improved cloud computing.

### BACKGROUND OF THE INVENTION

Currently available cloud architectures have deficiencies that do not allow them to quickly adapt to different usage deployment models. Compute-based clusters need compute cycles with minimal storage. Storage-based clusters need few compute cycles, but need large amounts of storage. Further, currently available cloud specific nodes are limited in what they can configure.

Therefore, it may be desirable to provide a cloud computing architecture which addresses the above-referenced shortcomings of currently available solutions.

### SUMMARY OF THE INVENTION

Accordingly, an embodiment of the present invention is directed to an architecture, including: a plurality of servers; a plurality of Serial Attached Small Computer System Interface (SAS) switches, the plurality of SAS switches being connected to the plurality of servers; and a storage system, the storage system configured for being communicatively coupled to the plurality of servers via the plurality of SAS switches, wherein the architecture is configured for dynamically mapping data stores of the storage system to the servers.

A further embodiment of the present invention is directed to an architecture, including: a plurality of diskless server nodes; a plurality of Serial Attached Small Computer System Interface (SAS) switches, the plurality of SAS switches being connected to the plurality of diskless server nodes; and a storage system, the storage system configured for being communicatively coupled to the plurality of servers via the plurality of SAS switches, wherein the architecture is configured for dynamically mapping data stores of the storage system to the server nodes.

A still further embodiment of the present invention is directed to an architecture, including: a plurality of diskless server nodes; a plurality of Serial Attached Small Computer System Interface (SAS) switches, the plurality of SAS switches being connected to the plurality of diskless server nodes; and a storage system, the storage system configured for being communicatively coupled to the plurality of servers via the plurality of SAS switches, wherein the storage system is configured for implementing Controlled Replication Under Scalable Hashing (CRUSH) redundancy, wherein the architecture is configured for dynamically mapping data stores of the storage system to the server nodes.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustration of an architecture for promoting improved cloud computing in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

Currently available cloud architectures have deficiencies that do not allow them to quickly adapt to different usage deployment models. Compute-based clusters need compute cycles with minimal storage. Storage-based clusters need few compute cycles, but need large amounts of storage. Further, currently available cloud specific nodes are limited in what they can configure. Still further, currently available cloud architectures do not utilize traditional Redundant Array of Inexpensive Disks (RAID) capability since redundancy is inherent in the cloud middleware. The architecture of the present invention disclosed herein: a.) allows for complete dynamic configurability; b.) is compatible with existing cloud middleware components; and c.) implements new methods of Controlled Replication Under Scalable Hashing (CRUSH) redundancy to provide more efficient data redundancy while still allowing higher level mechanisms for more extreme failure mechanisms.

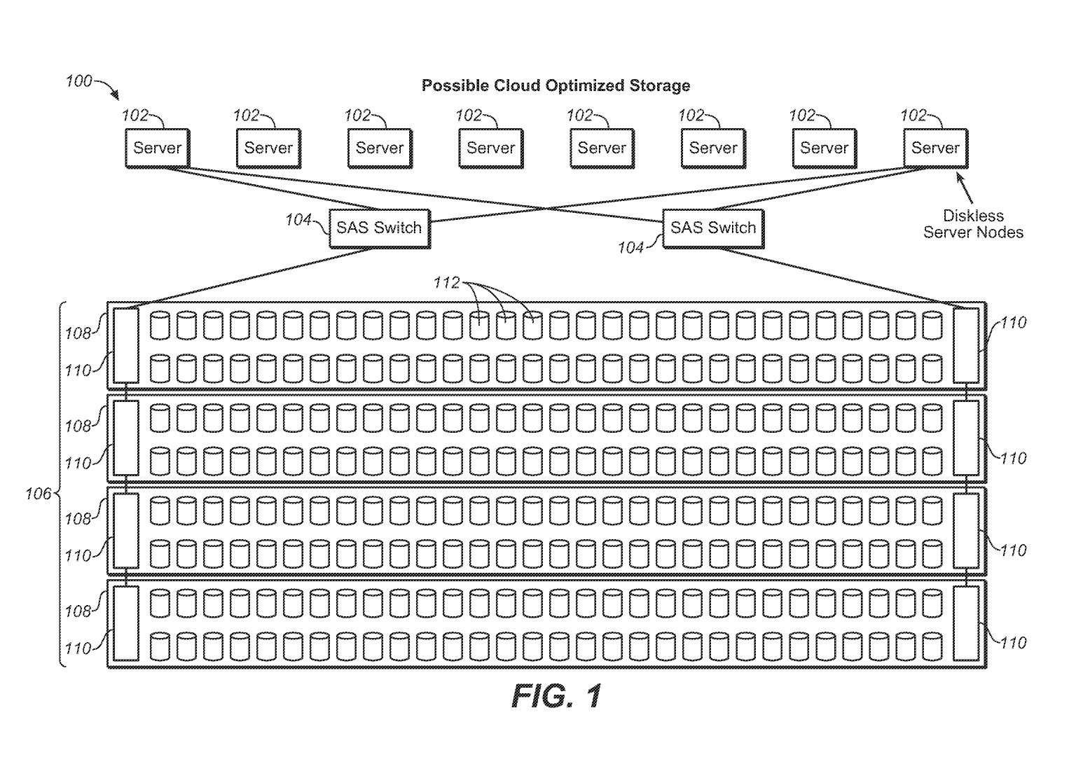

Referring to FIG. 1, an architecture 100 for promoting improved cloud computing (ex.—a cloud computing architecture 100) is shown. In an exemplary embodiment of the present invention, the architecture 100 may include a plurality of servers 102 (exs.—server nodes, processor cards, processors, central processing units (CPUs)). For example, the architecture 100 may include eight servers 102 (ex.—eight processor cards 102). In further exemplary embodiments of the present invention, the servers 102 (ex.—processor cards 102) may include limited or no storage (ex.—may not include drives). For instance, the servers 102 (ex.—server nodes 102) may be diskless server nodes (DSN) 102, such that the servers 102 do not include a boot drive(s). Thus, the servers 102 (ex.—processors 102) of the architecture 100 of the present invention are not tied to (ex.—do not include) storage, even for boot.

In current exemplary embodiments of the present invention, the architecture 100 may include one or more switches 104. For example, the switches 104 may be Serial Attached Small Computer System Interface (SAS) switches 104. The switches 104 may be configured for being connected to the servers 102.

In exemplary embodiments of the present invention, the architecture 100 may include a storage system 106. In further embodiments of the present invention, the storage system 106 may be configured for being connected to the plurality of servers 102 via the SAS switches 104, said SAS switches 104 configured for facilitating data communications between servers 102 and the storage system 106. In still further embodiments of the present invention, the storage system 106 may include a plurality of storage subsystems 108, each of the storage subsystems 108 configured for being connected (ex.—communicatively coupled) to each other. In further embodiments of the present invention, each storage subsystem 108 may include one or more storage controllers 110. In still further embodiments of the present invention, each storage subsystem 108 may further include a plurality of disk drives 112, said disk drives 112 being connected to the storage controllers 110. For example, the storage system 106 may include six hundred disk drives 112. In exemplary embodiments of the present invention, the storage subsystems 108 may be communicatively coupled to each other via the storage controllers 110. In further embodiments of the present invention, the storage controllers 110 of the storage system 106 may be communicatively coupled to the servers 102 via the SAS switches 104.

In current exemplary embodiments of the present invention, the storage system 106 is configured for implementing Controlled Replication Under Scalable Hashing (CRUSH) redundancy (ex.—is configured for utilizing large CRUSH data configuration) to provide more efficient data redundancy (ex.—flexible CRUSH mappings) while still allowing higher level mechanisms for more extreme failure mechanisms. Controlled Replication Under Scalable Hashing (CRUSH) is a mechanism for mapping data to storage objects which was developed by the University of California at Santa Cruz. For example, CRUSH techniques are disclosed in: CRUSH: Controlled, Scalable, Decentralized Placement of Replicated Data., Weil et al., Proceedings of SC '06, November 2006, which is herein incorporated by reference in its entirety. CRUSH allows redundancy methods to operate independently of data placement algorithms. For example, a CRUSH system may have as its redundancy mechanism a Redundant Array of Inexpensive Disks (RAID) mechanism/a RAID stripe, such as a RAID 5 4+1 stripe. Each stripe of information on this redundancy group/redundancy mechanism may be mapped by CRUSH to a set/subset of 5 drives within a set of drives of the CRUSH system. Each subsequent stripe of data may be mapped to another set/subset of 5 drives within the set of drives of the CRUSH system.

In exemplary embodiments of the present invention, the servers 102 (ex.—processor cards 102) may be dynamically mapped to application and storage requirements. In further embodiments of the present invention, the architecture 100 allows for dynamic virtualized storage. In still further embodiments of the present invention, the architecture 100 allows for flexible mappings between the servers 102 (ex.—CPUs 102) and the disk drives 112 of the storage system 106. In further embodiments of the present invention, the architecture 100, by providing for flexible CRUSH mappings (as mentioned above), allows for: high performance on all volumes of the storage system 106; implementation of RAID redundancy mechanisms, including RAID 6; and fast rebuilds (which may promote a reduction in upper level data copies as well as promoting a decrease in network traffic (such as in a drive failure environment)). In still further embodiments of the present invention, the architecture 100 allows for dynamic configuration of performance node(s) versus storage node(s).

In current exemplary embodiments of the present invention, the servers 102 (ex.—processor cards 102) of the architecture 100 may not include drives (as mentioned above), thus, the architecture 100 may allow for the use of operating system (OS) snapshots from a single volume and/or may allow for the implementation or use of flash swap space. In still further embodiments of the present invention, the architecture 100 may allow for replication at a Distributed File System (DFS) layer, there allowing said architecture to be compatible with current cloud computing infrastructure. In further embodiments of the present invention, the architecture 100 may allow for extremely quick rebuilds after failures occur. In still further embodiments of the present invention, the architecture 100 may promote the elimination of thrashing at a DFS layer except in the case of catastrophic errors (such as server failures, multiple drive failures), thus increasing effective user bandwidth. In further embodiments of the present invention, the architecture 100 allows for the elimination of traditional Storage Area Network (SAN) infrastructure.

In exemplary embodiments of the present invention, the architecture 100 may allow for improved control for provisioning of resources (ex.—provisioning of processor and storage resources). For example, the architecture 100 of the present invention may allow for allocation of amounts of storage power and processor power for an application. In further embodiments of the present invention, the architecture 100 may allow for expansion capability (ex.—scale-out expansion capability) for promoting improved bandwidth and capacity. In still further embodiments of the present invention, the architecture 100 allows full customer replaceability. In further embodiments of the present invention, the architecture 100 is compatible with currently available cloud software, which may run on the servers 102 (ex.—server nodes 102) without change. In still further embodiments of the present invention, the architecture 100 may be configured (ex.—sized) for implementation within a server cabinet (ex.—a 44U server cabinet). In further embodiments of the present invention, the architecture 100 may be configured (ex.—sized) such that it abstracts well to a container (ex.—a shipping container). The dynamic mapping capability provided by the architecture 100 allows for such abstraction capabilities. For instance, the servers 102 and storage system 106 may be sized such that at least two thousand servers 102 and their associated storage system 106 may fit into a standard cloud shipping container.

In current exemplary embodiments of the present invention, the architecture 100 removes any dependencies on processor and storage nodes, thereby allowing for complete flexibility in terms of dynamically configuring any type of cloud computing node. In further embodiments of the present invention, the architecture 100 allows for very fast recovery from disk failures and allows any components of the architecture 100 to be replaced with a customer replaceable unit (CRU), all while retaining existing cloud middleware. In still further embodiments of the present invention, the storage system 106 of the architecture 100 is SAS-switched and utilizes large CRUSH data configuration that allows for fast rebuilds of drive failures. In further embodiments of the present invention, the architecture 100 utilizes a virtualized mapping structure which allows for data stores (of the storage system 106) to be dynamically custom-mapped to the appropriate server 102 (ex—processor complex 102) for a task that is being allocated. This also includes boot capability of the node (ex.—the cloud computing node), which may be a writable snapshot of an operating system (OS) boot node. In still further embodiments of the present invention, the architecture 100 is configured for allowing full customer replaceability of the architecture's components and promotes improved performance over existing architectures for cloud computing.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. An architecture, comprising:
a plurality of servers;
a plurality of Serial Attached Small Computer System Interface (SAS) switches, the plurality of SAS switches being connected to the plurality of servers; and
a storage system, the storage system configured for being communicatively coupled to the plurality of servers via the plurality of SAS switches,
wherein the architecture is configured for dynamically mapping data stores of the storage system to the servers.

2. An architecture as claimed in claim 1, wherein the storage system includes a plurality of storage subsystems, each storage subsystem included in the plurality of storage subsystems including at least one storage controller.

3. An architecture as claimed in claim 2, wherein each storage subsystem included in the plurality of storage subsystems includes a plurality of disk drives, the plurality of disk drives being connected to the at least one storage controller.

4. An architecture as claimed in claim 1, wherein the plurality of servers are diskless server nodes (DSN).

5. An architecture as claimed in claim 1, wherein the storage system is configured for implementing Controlled Replication Under Scalable Hashing (CRUSH) redundancy.

6. An architecture as claimed in claim 1, wherein the architecture is a cloud computing architecture.

7. An architecture as claimed in claim 1, wherein the storage system is configured for implementing Redundant Array of Inexpensive Disks (RAID) redundancy.

8. An architecture, comprising:
a plurality of diskless server nodes;
a plurality of Serial Attached Small Computer System Interface (SAS) switches, the plurality of SAS switches being connected to the plurality of diskless server nodes; and
a storage system, the storage system configured for being communicatively coupled to the plurality of servers via the plurality of SAS switches,
wherein the architecture is configured for dynamically mapping data stores of the storage system to the server nodes.

9. An architecture as claimed in claim 8, wherein the storage system includes a plurality of storage subsystems, each storage subsystem included in the plurality of storage subsystems including at least one storage controller.

10. An architecture as claimed in claim 9, wherein each storage subsystem included in the plurality of storage subsystems includes a plurality of disk drives, the plurality of disk drives being connected to the at least one storage controller.

11. An architecture as claimed in claim 8, wherein the storage system is configured for implementing Controlled Replication Under Scalable Hashing (CRUSH) redundancy.

12. An architecture as claimed in claim 8, wherein the architecture is a cloud computing architecture.

13. An architecture as claimed in claim 8, wherein the storage system is configured for implementing Redundant Array of Inexpensive Disks (RAID) redundancy.

14. An architecture, comprising:
a plurality of diskless server nodes;
a plurality of Serial Attached Small Computer System Interface (SAS) switches, the plurality of SAS switches being connected to the plurality of diskless server nodes; and
a storage system, the storage system configured for being communicatively coupled to the plurality of servers via the plurality of SAS switches, wherein the storage system is configured for implementing Controlled Replication Under Scalable Hashing (CRUSH) redundancy,
wherein the architecture is configured for dynamically mapping data stores of the storage system to the server nodes.

15. An architecture as claimed in claim 14, wherein the storage system includes a plurality of storage subsystems, each storage subsystem included in the plurality of storage subsystems including at least one storage controller.

16. An architecture as claimed in claim 15, wherein each storage subsystem included in the plurality of storage subsystems includes a plurality of disk drives, the plurality of disk drives being connected to the at least one storage controller.

17. An architecture as claimed in claim 16, wherein the plurality of storage subsystems are communicatively coupled to each other.

18. An architecture as claimed in claim 14, wherein the architecture is a cloud computing architecture.

19. An architecture as claimed in claim 14, wherein the storage system is configured for implementing Redundant Array of Inexpensive Disks (RAID) redundancy.

20. An architecture as claimed in claim 19, wherein the storage system is configured for implementing RAID 6
